(19) United States
(12) Patent Application Publication
(10) Pub. No.: US 2017/0347319 A1
(43) Pub. Date: Nov. 30, 2017

(54) CENTRALIZED CONTROL OF ACCESS POINT RADIOS IN A WIRELESS NETWORK

(71) Applicant: P2 Wireless Technologies Limited, Hong Kong Science Park (HK)

(72) Inventor: Pak Kit LAM, Hong Kong Science Park (HK)

(73) Assignee: P2 Wireless Technologies Limited, Hong Kong Science Park (HK)

(21) Appl. No.: 15/169,654

(22) Filed: May 31, 2016

(51) Int. Cl. H04W 52/02; H04L 29/08; H04L 12/26

(52) U.S. Cl. CPC H04W 52/0258; H04L 43/16; H04L 67/306

(57) ABSTRACT

In a computer-enabled method, at a wireless network access point configured to operate in a wireless network, wherein the wireless network access point comprises a plurality of radios, a load on the wireless network access point is determined, while at least two radios of the plurality of radios are powered on. In response to the load transitioning from above a threshold to below the threshold, at least one of the powered-on radios is powered off while leaving the remaining radios of the plurality of radios powered-on.

### BACKGROUND

### 1. Field

The present disclosure relates to power management for wireless networks.

### 2. Description of Related Art

In some conventional wireless networks, an access point covers a particular geographical area of interest (e.g., room, floor of a building, etc.). Typically, the access point remains powered on when not in use. For example, the access point is powered on and emits radio frequency (RF) signals (e.g., WiFi signals) even when there are no wireless devices connected to (or attempting to connect to) the access point. In other words, the access point, even when not in use, consumes energy and emits RF signals that may be a health hazard to some individuals.

### SUMMARY

Embodiments described herein provide for centralized management of access points in a wireless network. For example, a user may remotely provide configuration instructions to one or more access points in a wireless network from a central location.

Embodiments described herein also provide for automatically powering on an access point at a predetermined time(s). Moreover, the number of powered on radios, in the access point, may be automatically incremented/decremented based on load thresholds on the access point. Accordingly, the access point may be fine-tuned, on a per radio basis, without requiring to manually powering off the access point, as a whole, or manually turning off individual radios in the access point.

In some embodiments, a computer-enabled method, comprises: at a wireless network access point configured to operate in a wireless network, wherein the wireless network access point comprises a plurality of radios: determining a load on the wireless network access point, while at least two radios of the plurality of radios are powered on; and in response to the load transitioning from above the threshold to below the threshold, powering off at least one of the powered-on radios while leaving the remaining radios of the plurality of radios powered-on.

In some embodiments, a non-transitory computer-readable storage medium having computer-executable instructions, wherein the computer-executable instructions, when executed by one or more processors of a wireless access point, causes the wireless access point to power on or power off one or more radios of a plurality of radios of the wireless access point, the computer-executable instructions comprising instructions for: determining a load on the wireless network access point, while at least two radios of the plurality of radios are powered on; and in response to the load transitioning from above a threshold to below the threshold, powering off at least one of the powered-on radios while leaving the remaining radios of the plurality of radios powered-on.

In some embodiments, a wireless access point comprises: a plurality of radios coupled to one or more processors; a memory coupled to the one or more processors; and one or more programs, wherein the one or more programs are stored in the memory and configured to be executed by the one or more processors, the one or more programs including instructions for: determining a load on the wireless network access point, while at least two radios of the plurality of radios are powered on; and in response to the load transitioning from above a threshold to below the threshold, powering off at least one of the powered-on radios while leaving the remaining radios of the plurality of radios powered-on.

### DESCRIPTION OF FIGURES

FIG. 1 depicts a block diagram of a wireless network in accordance with some embodiments.

FIG. 2 depicts a block diagram of an access point of a wireless network in accordance with some embodiments.

FIG. 3 is a flow diagram illustrating a process for turning on/off an access point at predetermined times in accordance with some embodiments.

FIG. 4 is a flow diagram illustrating a process for selectively turning on/off radios of an access point in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments. The various embodiments are not intended to be limited to the examples described herein and shown, but are to be accorded the scope consistent with the claims. For example, embodiments of the invention are described below with respect to a wireless network. That is, a wireless network is one example of a network that could be used to implement the embodiments of the invention as described below. However, the embodiments of the invention, as described below, may be implemented in various wireless networks in general.

### Embodiments of a Wireless Network

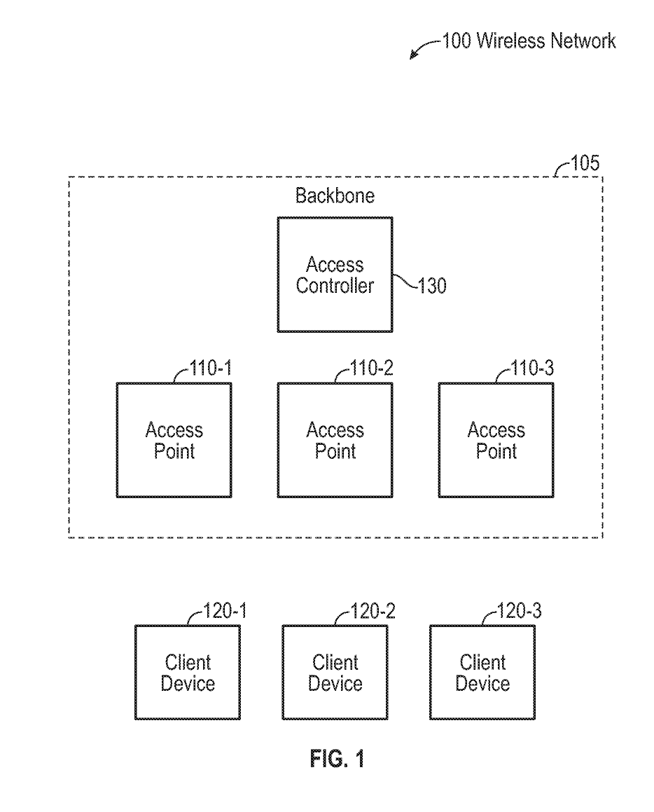

FIG. 1 illustrates an exemplary wireless network 100 comprising, among other things, wireless network backbone 105. In general, wireless network 100 is formed using a backbone of relaying devices (or nodes) that are able to communicate with one another, in a wired or wireless manner, such that network data can travel between the nodes until the network data reaches its destination (e.g., client device).

As depicted in FIG. 1, wireless network backbone 105 comprises various nodes. The nodes can be, but are not limited to, various wireless network relaying devices (WMR) (e.g., access points 110 or routers, etc.), and access controller 130. Additionally, network 100 includes other nodes, such as client devices 120 that access wireless network 100 via access points 110.

Access controller 130 is configured to provide centralized management of the access points (and/or any other WMRs) in network 100. For example, access controller 130 is able to send configuration instructions (or configuration settings) to any one of the access points in wireless network 100. The configuration instructions can include instructions for time(s) to power on/off the access points. More specifically, the configuration instruction can include instructions to power on/off particular radios in one or more access points, based on various criteria, which will be described in further detail below.

Although FIG. 1 depicts three access points, (e.g., access points 110-1, 110-2, and 110-3), it should be appreciated that wireless network 100 can include any number of access points. Additionally, although FIG. 1 depicts three client devices (e.g., client devices 120-1, 120-2, and 120-3), it should be appreciated that any number of client devices can access wireless network 100 via the access points in backbone 105. Client devices 120 may be any wireless devices that are capable of wirelessly connecting with wireless network 100 via access points 110. For example, a client device may be a smart phone, tablet, personal computer, etc.

As will be described in further detail below, each access point 110 (or WMR) includes at least two radios (each associated with one or more antenna) for communicating with other nodes, such as client devices. As a result, the nodes of wireless network backbone 105 are connected so that network data, such as a network packet, can travel from a source to a destination (e.g., client devices 120) through intermediate nodes (or WMRs).

### Embodiments of an Access Point

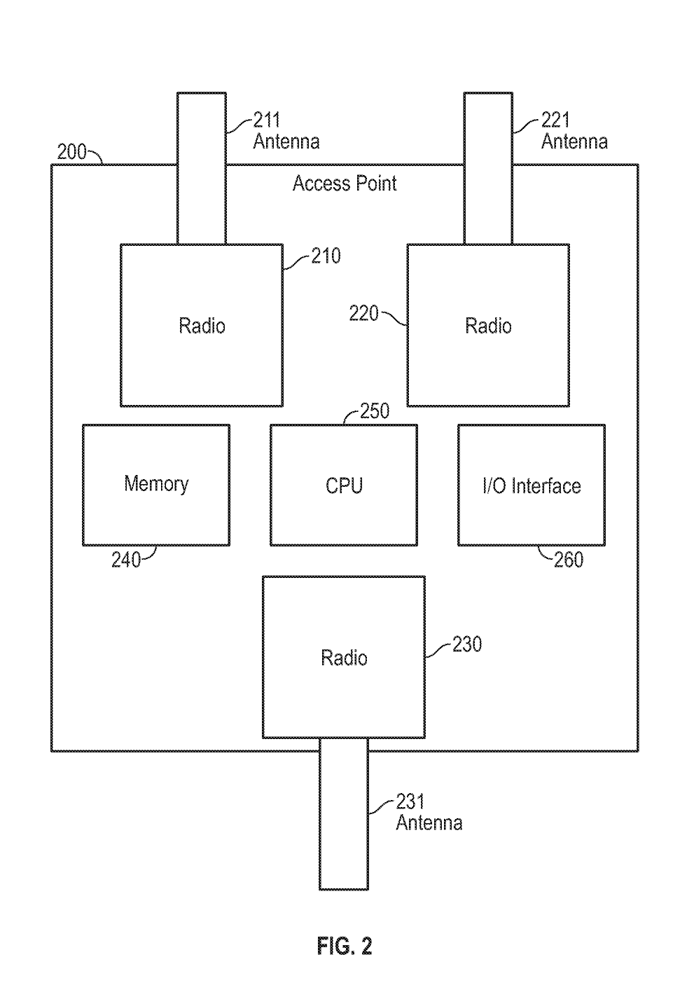

FIG. 2 depicts an embodiment of access point 200. Access point 200 is similar to access points 110, as depicted in FIG. 1. Access point 200 includes at least two radios (and respective antennas). As shown in FIG. 1, access point 200 includes three radios (e.g., radios 210, 220 and 230). Other access points 200 may include more than three radios (and respective antennas). Each radio is communicatively coupled to at least one antenna. For example, radio 210 is communicatively coupled to antenna 211, radio 221 is communicatively coupled to antenna 221, and radio 230 is communicatively coupled to antenna 231.

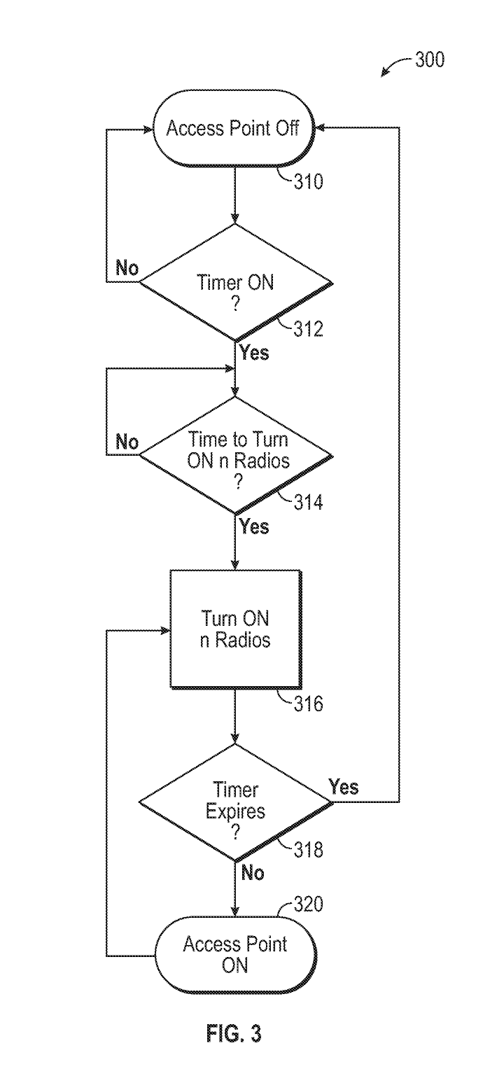

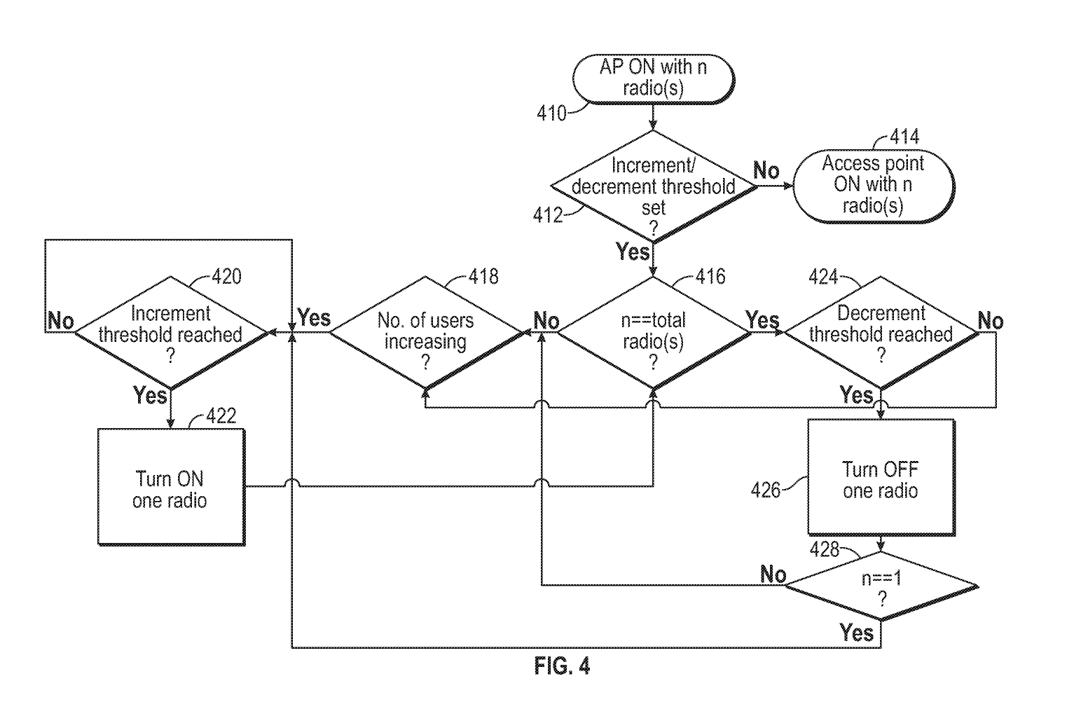

Access point 200 includes memory 240, at least one central processing unit (CPU), and I/O interface 260. Memory 240 includes a non-transitory storage medium that stores instructions, such as instructions executable by CPU or processor 250. In some examples, the instructions, when executed, cause access point (e.g., access points 110-1, 110-2, and 110-3) to perform various processes (e.g., process 300 (FIG. 3) and/or process 400 (FIG. 4)). In one case, instructions that are executed by CPU 250 are configuration instructions received from access controller 130. I/O interface 260 includes a USB port that facilitates configuration of device 200, in some examples.

### Embodiments of a Process for Turning ON/OFF an Access Point at Predetermined Times

FIG. 3 depicts a flow diagram illustrating a process 300 for turning on/off an access point at predetermined times, in accordance with various embodiments. The Appendix, provided below, includes pseudo-code that describes, at least in part, one or more embodiments of process 300. At block 310 of process 300, the access point is turned off (or is in the off mode). That is, each of the radios (e.g., radios 210, 220, and 230) of the access point is not powered on. A radio that is not powered on or is powered off may not be supplied any power. When the access point is powered off, the transmission power (Tx power) for each radio is set to 0. In other words, there is no transmission power associated with any of the radios. Alternatively, radios not powered on or powered off may also be in a low-power or stand-by state which consumes little to no power.

At block 312, it is determined whether the timer is on, and determining if it is the predetermined time to turn on the radio. For example, if an access point is scheduled to be turned on at noon, then it is determined whether or not a timer is accounting for the current time. In this example the “timer” is a predetermined time for turning on/off an access point. For example, a timer is a clock that determines when the access point is to turn on/off at a predetermined time(s).

At block 314, it is determined whether or not it is time to turn on n radios of the access point. For example, if the access point is determined to be turned on at noon, and the timer determines that it is noon, then n radios of the access point are to be turned on at the predetermined time. At least one radio is powered on when an access point is powered on. If it is determined that it is not the predetermined time to turn on the access point, the access point remains powered off.

At block 316, in response to the determination that the predetermined time to turn on the access point is met, the access point is turned on. That is, at least one radio of the access point is turned on. It may be determined to turn on more than one radio at the predetermined time to turn on the access point.

When a radio is turned on, the power transmission of the radio increases to a particular value. For example, a software driver enables the power transmission of the radio to increase to a predetermined value, such as a maximum value (MAX), or any other value between 0 and the maximum power transmission value.

At block 318, it is determined whether or not the timer has expired. That is, it is determined if the predetermined time to turn off the access point has been met. If the timer has expired, then the access point is turned off. For example, the access point may have been configured to be on for a set period of time (e.g., 5 hours). Alternatively, the timer may be set to expire at a specific time, such as at 5 P.M.

At block 320, if at block 318 it is determined that the timer is not expired, then the access point remains on. For example, the access point remains powered on because at least one radio is powered on. Alternatively, at block 320 if it is determined that the timer has expired, then process 300 is restarted with the access point being turned off and returning to block 310 of process 310.

Process 300 may be performed by CPU 200 executing configuration instructions received from access controller 130.

### Embodiments of a Process to Selectively Turn ON/OFF Radios of an Access Point

FIG. 4 depicts a flow diagram illustrating a process 400 for selectively turning on/off individual radios of an access point, in accordance with various embodiments. More specifically, process 400 provides for incrementing/decrementing the number of radios that are powered on based on one or more increment/decrement thresholds, which will be described in further detail below. Moreover, the Appendix, provided below, includes pseudo-code that describes, at least in part, one or more embodiments of process 400.

The configuration instructions to implement process 400 may be received at an access point via access controller 130. For example, a technician remotely provides configuration instructions to access point 200 via access controller 130. It should be appreciated that configuration instructions can be transmitted as configuration file, from access controller 130, over the wireless network, to a plurality of access points (e.g., access points 110-1, 110-2, and 110-3) in the wireless network.

The configuration instructions may include, but are not limited to, location of an access point, predetermined time(s) an access point is scheduled to be turned on/off, the number of initially powered on radios, and the increment/decrement thresholds. The predetermined time(s) indicate the time(s) at which the access point is intended or expected to be active.

The increment/decrement thresholds indicate the criteria at which at least one radio of a plurality of radios is to be turned on or off based on the load at the access point. For example, the load may be the number of users (or wireless devices) connected to (and/or attempting to connect to) the access point. In another example, the load may be the network traffic handled by the access point.

An example of configuration instructions is shown in Table 1 below.

TABLE 1

| | Predetermined time(s) AP | Radio | Radio | Radio |
|---|---|---|---|---|
| Location | is powered on | #1 | #2 | #3 |
| Classrooms | During any computer or | <30 | 31-60 | >60 |
| | math class | users | users | users |
| Corridor | 7am-7pm, Monday-Friday | | | |
| Canteen | 11am-2pm, Monday-Friday | | | |
| | 10am-2pm, Saturday-Sunday | | | |

Referring to Table 1, each of the access points (e.g., access point 200) located in a classroom are scheduled to be turned on during any computer or math class. Additionally, the three radios for each access point are to be turned on/off based on various increment/decrement thresholds (e.g., <30 users, 31-60 users, and >60 users).

Similarly, access points located in the corridor are scheduled to be turned on between 7 am and 7 pm on Monday through Friday, and access points located in the canteen are scheduled to be turned on between 11 am and 2 pm on Saturday through Sunday. The three radios for each of the access points are to be turned on/off based on various increment/decrement thresholds (e.g., <30 users, 31-60 users, and >60 users).

Description of process 400, provided in detail below, will include examples related to the non-limiting configuration instructions depicted in Table 1.

At block 410 of process 400, the access point is powered on because at least one radio is powered on. The configuration instructions, in one embodiment, specify the number of radios that are initially turned on. For example, radio 210 (e.g., Radio #1) is turned on, while radio 220 (e.g., Radio #2), and radio 230 (e.g., Radio #3) are not powered on. In another example, at least two radios (e.g., radio 210 and radio 220) are initially powered on.

In one example, block 410 is similar to block 320 of process 300. Accordingly, in such an embodiment, process 400 is a continuation of process 300.

At block 412, it is determined whether a increment/decrement threshold is set for an access point. For example, the configuration instructions in Table 1 include increment/decrement thresholds (e.g., <30 users, 31-60 users, >60 users) for each of the radios in the access point. Accordingly, the number of radios powered on will increment/decrement based on the increment/decrement thresholds that are based on the load of the access point.

At block 414, if it is determined at block 412 that no thresholds are set for the access point, then the access point remains on with the initial number of turned on radios provided at block 410 of process 400.

At block 416, if it is determined at block 412 one or more increment/decrement thresholds has been set for the access point, then it is determined whether the initial number of radios powered on (e.g., one radio) equals the maximum number of radios in the access point (e.g., three radios). In one instance, if the number of initially powered on radios (N) is less than the total number of radios (e.g., N<total radios), then the access point tracks the number of users associated with the access point.

In another instance, if the number of initially powered on radios (N) equals the total number of radios (e.g., N=total radios), then the access point forgoes tracking the number of users associated with the access point. The access point, however, may still track the number of users to determine whether a radio should be turned off to conserve power, as discussed below.

At block 418, if it is determined at block 416 that all radios are not powered on, then it is determined whether the load on the access point (e.g., the number of users connected to the access point) is increasing. For example, the number of users connected to radio 210 (e.g., Radio #1) increases from 28 users to 30 users.

At block 420, if it is determined at block 418 that the load on the access point is increasing (e.g., the load has increased from below the threshold to above the threshold), then it is determined whether an increment threshold is reached. For example, referring to Table 1, there is a first increment threshold (between “<30 users” and “31 to 60 users”), and a second increment threshold (between “31 to 60 users” and “>60 users”). If the number of users (or client devices connected to the access point) increases to 30 users (while Radio #1 is powered on), then it is determined that the first increment threshold has been met.

In another example, if the number of users (or client devices connected to the access point) increases to 61 users (while Radio #1 and Radio #2 are powered on), then it is determined that a second increment threshold has been met.

At block 422, if it is determined at block 420 that the load has increased beyond the threshold, then the number of radios powered on is automatically (e.g., without manual action) incremented. For example, in response to the number of users increasing to 30 users, radio 220 (e.g., Radio #2) is automatically powered on. As a result, in some embodiments, the additional users (e.g., the 31st through 60th users) are connected to radio 220 (e.g., Radio #2).

It is noted that when a user is associated (or registered) with a radio (e.g., radio 220) of an access point, a user profile is created and stored in memory. The user profile indicates, among other things, that the user is associated with a particular powered-on radio (e.g., radio 220) of the access point.

More specifically, the user profiles are stored in memory and identified by a “structure” within the source code, wherein one of the data fields is a pointer to the associated radio. Additionally, a radio is considered a “resource” in the source code that may be switched on/off.

When a user profile is associated with a radio the user profile points to the associated radio using the pointer within the structure. If the association of the user profile is to be changed to another radio, then the pointer (within the structure) will be changed to point to another radio. This process is also referred to as the “re-registration process,” described in further detail below.

In another example, in response to the number of users increasing to 61 users, radio 230 (e.g., Radio #3) is powered on. As a result, in some embodiments, the additional users (e.g., the 60th and above users), are associated with or connected to radio 230 (e.g., Radio #3).

In one embodiment, if the number of users continues to increase, then the number of radios powered on is automatically incremented until the number of powered on radios equals the total number of radios included in the access point.

At block 424, if it is determined at block 416 that all radios are powered on, then it is determined whether a decrement threshold is reached. For example, referring to Table 1, there is a first decrement threshold (between “31 to 60 users” and “>60 users”), and a second decrement threshold (between “<30 users” and “31 to 60 users”). If the number of users (or client devices connected to the access point) decreases to 60 users from 65 users (while Radio #1, Radio #2 and Radio #3 are powered on), then it is determined that the first decrement threshold has been met.

In another example, if the number of users (or client devices connected to the access point) decreases from 32 users to 29 users (while Radio #1 and Radio #2 are powered on), then it is determined that a second decrement threshold has been met.

At block 426, if it is determined at block 424 that the load has fallen from above the threshold to below the threshold, then one or more radios are turned off (or the number of powered on radios is decremented), while leaving the remaining radios powered on. For example, in response to the number of users decreasing to 60 users from 65 users, radio 230 (e.g., Radio #3) is powered off, while leaving radios 210 and 220 powered on. As a result, in some embodiments, any users that are connected to the to-be-turned-off radio 230 (e.g., Radio #3) are dissociated from to-be-turned-off radio 230 and re-registered in (or re-associated with) with any of the remaining powered on radios, such as radio 210 (e.g., Radio #1) or radio 220 (e.g., Radio #2). In this example, radio 230 is powered off after the users are re-registered with the remaining powered on radio.

In another example, in response to the number of users decreasing to 29 users from 31 users, radio 220 (e.g., Radio #2) is powered off. As a result, in some embodiments, any users that are connected to the soon-to-be-turned-off radio 220 (e.g., Radio #2) are re-registered in (or re-associated with) with powered on radio 210 (e.g., Radio #1). It should be appreciated that the users may experience a short delay or suspension in access to network 100 during the re-registration process.

It should be appreciated that if the number of users decreases but does not exceed the first or second decrement thresholds, then the access point forgoes powering off at least one of the powered on radios.

In one embodiment, during the re-registration process, the portfolios of the users associated with the to-be-turned-off radio (e.g., Radio #2 or Radio #3) are transferred or migrated to a remaining powered on radio (e.g., Radio #1) so as to maintain the connection between the users and the access point. For example, as described above, if the association of a user profile is changed from Radio #2 to Radio #1, then the pointer, associated with the user profile, changes such that it points to Radio #1 (rather than Radio #2).

At block 428, if the number of users continues to decrease, then the number of radios powered off is automatically decremented until the number of powered on radios equals one. As stated herein, the access point includes at least one powered on radio when the access point is powered on.

Process 400 may be performed by CPU 200 executing configuration instructions received from access controller 130.

The disclosure includes various embodiments and examples as described herein. It should be appreciated that such embodiments and examples may be implemented alone or in combination with one another. For example, an embodiment of a feature or functionality of an access point may be implemented with one or more other embodiments of features/functionalities of the access point, as described herein.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

### APPENDIX

```
APPENDIX
// Using a 3-RADIO AP as an example.
// RADIO_1, RADIO_2 and RADIO_3 can be manipulated by the CPU.
// When a radio is being turned ON, its Tx power will be set to MAX. When a radio is being
turned OFF, its Tx power is set to 0.
If (ap_power == ON)
{
//Radio_1 must be turned ON regardless of the number of associated users. The other 2 radios
are OFF by default.
        tx_pwr(RADIO_1) = MAX;
}
while ( (num_associated_user increases) || (num_associated_user decreases) )
{
//Whenever there is a user associating to the AP (num_associated_user increases) OR
disassociating from the AP (num_associated_user decreases), the following will execute.
      If (num_associated_user > =SECOND_THRESHOLD)
      {
      //When the number of associated users is above the second threshold, the Tx power of the
      third radio will be turned ON. If it is already ON, it will stay ON.
            tx_pwe(RADIO_3) = ON;
      }
      Else if ((num_associated_user < SECOND_THRESHOLD) && (num_associated_user >
      =FIRST_THRESHOLD))
      {
      // When the number of associated users is between the first and the second thresholds,
      there are 2 possibilities:
```

| | |
|---|---|
| i. | The number of associated users increases to above the first threshold - RADIO_2 |
| | will be turned ON. If it is already ON, it will stay ON. |
| ii. | The number of associated users decreases to below the second threshold -- |
| | RADIO_3 will be turned OFF. If it is already OFF, it will stay OFF. The profiles |
| | of the users currently associated with RADIO_3, if there is any, will be moved |
| | RADIO_2. |
| | tx_pwe(RADIO_2) = ON; |
| | tx_pwe(RADIO_3) = OFF; |
| | if (there are users associated with RADIO_3) |
| | { |
| | Move all the profiles to be associated with RADIO_2; |
| | } |

```
      }
      Else
      {
      // When the number of associated users is below the first threshold, RADIO_2 will be
      turned OFF. If it is already OFF, it will stay OFF. The profiles of the users currently
      associated with RADIO_2, if there is any, will be moved RADIO_1.
```

| | |
|---|---|
| | tx_pwe(RADIO_2) = OFF; |
| | if (there are users associated with RADIO_2) |
| | { |
| | Move all the profiles to be associated with RADIO_1; |
| | } |
| } | |

What is claimed is:

1. A computer-enabled method, comprising:
at a wireless network access point configured to operate in a wireless network, wherein the wireless network access point comprises a plurality of radios:
determining a load on the wireless network access point, while at least two radios of the plurality of radios are powered on; and
in response to the load transitioning from above a threshold to below the threshold, powering off at least one of the powered-on radios while leaving the remaining radios of the plurality of radios powered-on.

2. The computer-enabled method of claim 1, further comprising:
in response to the load remaining above the threshold, forgo powering-off the at least one powered-on radios.

3. The computer-enabled method of claim 1, further comprising:
receiving a configuration setting from a network node of the wireless network, wherein the configuration setting defines the threshold.

4. The computer-enabled method of claim 1, further comprising:
receiving a configuration setting from a network node of the wireless network, wherein the configuration setting defines one or more of a predetermined time of powering on the wireless network access point, a number of radios initially powered on at the predetermined time of powering on the wireless network access point, and a predetermined time of powering off the wireless network access point.

5. The computer-enabled method of claim 4, further comprising:
in response to receiving the configuration setting from the network node, wherein the configuration setting defines the predetermined time of powering on the wireless network access point, powering on the wireless network access point at the predetermined time.

6. The computer-enabled method of claim 4, further comprising:
in response to receiving the configuration setting from the network node, wherein the configuration setting defines the predetermined time of powering off the wireless network access point, powering off the wireless network access point at the predetermined time.

7. The computer-enabled method of claim 1, further comprising:
in response to the load transitioning from above the threshold to below the threshold, changing an association of a user profile from a second radio of the at least two radios to a first radio of the at least two radios prior to powering off the second radio.

8. The computer-enabled method of claim 1, further comprising:
in response to the load transitioning from above the threshold to below the threshold, transitioning network nodes connected to a second radio of the at least two radios to a first radio of the at least two radios, wherein powering off at least one of the powered-on radios comprises powering off the second radio after transitioning the network nodes connected to the second radio.

9. The computer-enabled method of claim 1, further comprising:
in response to the load transitioning from below the threshold to above the threshold, powering on an additional radio of the plurality of radios.

10. The computer-enabled method of claim 1, wherein the determining a load on the wireless network access point further comprises:
determining a number of network nodes accessing the wireless network access point.

11. The computer-enabled method of claim 1, further comprising:
determining whether a number of powered-on radios is less than the total number of radios in the plurality of radios of the wireless access point, wherein, the determining the load on the wireless network access point is in response to the number of powered-on radios being less than the total number of radios.

12. The computer-enabled method of claim 11, further comprising:
in response to the number of powered-on radios being the total number of radios, forgoing a determination of the load on the wireless network access point.

13. A non-transitory computer-readable storage medium having computer-executable instructions, wherein the computer-executable instructions, when executed by one or more processors of a wireless access point, causes the wireless access point to power on or power off one or more radios of a plurality of radios of the wireless access point, the computer-executable instructions comprising instructions for:
determining a load on the wireless network access point, while at least two radios of the plurality of radios are powered on; and
in response to the load transitioning from above a threshold to below the threshold, powering off at least one of the powered-on radios while leaving the remaining radios of the plurality of radios powered-on.

14. A wireless access point comprising:
a plurality of radios coupled to one or more processors;
a memory coupled to the one or more processors; and one or more programs, wherein the one or more programs are stored in the memory and configured to be executed by the one or more processors, the one or more programs including instructions for:
determining a load on the wireless network access point, while at least two radios of the plurality of radios are powered on; and
in response to the load transitioning from above a threshold to below the threshold, powering off at least one of the powered-on radios while leaving the remaining radios of the plurality of radios powered-on.
